(19) United States
(12) Patent Application Publication
(10) Pub. No.: US 2004/0058121 A1
(43) Pub. Date: Mar. 25, 2004

(54) Flexible bundling and labeling device

(75) Inventors: Tavis D. Schriefer, Carrollton, TX (US); Edward A. Stanfield, Plano, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Ideative Product Ventures, Inc., Carrollton, TX

(21) Appl. No.: 10/662,176

(22) Filed: Sep. 12, 2003

Related U.S. Application Data
(60) Provisional application No. 60/410,360, filed on Sep. 13, 2002.
(60) Provisional application No. 60/443,160, filed on Jan. 28, 2003.

(51) Int. Cl. B32B 3/06

(52) U.S. Cl. 428/99; 428/100; 156/66

(57) ABSTRACT

A flexible device for labeling and/or bundling objects such as wires, cables, conduits, ring closures and the like, which includes a hook and loop fastener substrate adhered to a writable surface dimensions so that when the device is folded in half, the hook and loop material is engaged and accomplishes the labeling and/or bundling purpose.

### CROSS-REFERENCE TO RELATED APPLICATIONS

Priority is claimed to U.S. Provisional Applications No. 60/410,360, filed Sep. 13, 2002 and No. 60/443,160, filed Jan. 28, 2003 and which are incorporated herein by reference.

### BACKGROUND OF THE INVENTION

The invention relates to composite materials that provide for removable and reuseable mechanical fasteners and labels, methods of manufacture, products and uses therefore.

Hook and loop type fasteners are widely available and have a myriad of applications. A variety of devices have been developed to accomplish the task of labeling and/or bundling of materials including the securing, bundling and labeling of wires and cables. Many of these devices use hook and loop touch fastener material.

Certain of these labeling and bundling devices rely upon positioning the hook and loop material in a specific manner so that a wrapping process is necessary to accomplish the bundling task. In an example of one such wrapping device currently marketed under the trademark ONE-WRAP® by Velcro USA Inc. and as taught by Leach et al. in U.S. Pat. No. 6,551,539, a hook material is disposed on the top surface of a fastener strap while the loop material is disposed on the bottom surface. Similar bundling devices that have loop and hook elements on opposite sides of a substrate and thus require wrapping to engage the hook and loop elements are taught in U.S. Pat. No. 4,706,914 (Ground); U.S. Pat. No. 5,048,158 (Koerner); and U.S. Pat. No. 5,745,958 (Kaldor). Another type of hook and loop bundling device utilizes hook and loop elements on opposite sides of a strap material in such a way that a cinch type strap is provided. In one such cinch strap, as taught by Sastre at al in U.S. Pat. No. 6,044,525, one end of a strap has a slit through which the other end can be fed and looped back on the strap to mate the hook and loop elements. This type of device requires a significant amount of manipulation in order to secure the device around an object.

After the wrapping is complete with closure materials having hook elements on one side and loop elements on the other side, the exposed surface of the bundling device is either the hook or loop material of an indeterminate perimeter that is ill suited for displaying printed or written information. Similarly, there is no provision for a surface that accommodates printed or written information in the bundling devices having bands of hook or loop material covering both strap surfaces as taught by Hahn in U.S. Pat. No. 5,142,743.

One solution to the need for both bundling and labeling was disclosed by Tarrant in U.S. Pat. No. 4,656,767. Tarrant disclosed an identifying tag for cables in which a hook fastener panel and a separate loop type fastener panel are mounted on the same side of a plastic strip material in a spaced apart configuration. A clear pocket is mounted on an outer surface of the strip and identifying indicia may be inserted in the clear pocket to provide labeling of the cables. However, in such designs, the hook and loop material may become displaced with the shear pressure of tight bundling. Furthermore, the Tarrant cable tag does not provide for an outer surface that is directly writable.

A further cable management system having provision for branding and having separate hook and loop elements mounted on the same side of a backing material in a spaced apart configuration is disclosed by Behar in U.S. patent application Ser. No. 09/738,159, published as U.S. 2002/0073516 A1. In the Behar cable clip apparatus, the hook and loop elements are sewn or glued to an EVA foam backing and an outer piece of fabric. Neither the Tarrant nor Behar systems provide a hook and loop substrate that is resistant to shearing and provides a writable surface for identifying the object around which it is attached.

The need to organize and bundle various lengths of wire, cables and similar objects, has been long recognized. The purpose could be to save space for storage or to secure excess lengths of cable that are attached to a product in use, where the excess cable is cumbersome or hazardous. However, there is a further need for the bundling device that can be readily manufactured, is flexible, reusable and can be quickly applied with one hand. There is a further need to provide for removable and reusable labeling of objects, including bundled objects, on a surface that readily accepts writing and printing mediums. Such a device is also needed to provide reusable labeling devices that can be quickly applied and removed for such uses as identification of keys, bridles, collars and many other objects depending on the configuration of the device.

### BRIEF SUMMARY OF THE INVENTION

The present invention provides a labeling and/or bundling device that can be readily manufactured, is flexible, reusable and can be quickly applied with one hand. The invention further provides for removable and reusable labeling of objects, including bundled objects, on a surface that readily accepts writing and printing mediums. In one embodiment of the invention a labeling fastener device is provided that includes a flexible fastener substrate having a plurality of loop and hook elements, wherein both loop and hook elements are permanently embedded onto and extend outwardly from a single side of the substrate, and writable film adhered to and substantially covering a second side of the fastener substrate, wherein the fastener substrate and film together form a writable fastener device that may be closed by a single folding motion.

In another embodiment of the invention, the writable surface is composed primarily of a polypropylene or polyethylene film and is adapted to receive an image applied by ink-jet printing, laser printing, silk-screen printing or embroidery. If needed the film is treated to better receive and retain such images. The writable surface may be written upon with a writing instrument such as ball-point, felt, or gel pens.

In yet another embodiment of the invention, the fastener device is dimensioned for fastening around and providing a labeling surface to one or more objects such as wires, cables, conduits, tubing, pipes, lines, ring closures and the like and combinations thereof.

In still another embodiment of the fastener device, at least a portion of the writable surface further includes a transparent pocket for insertion of a label, wherein the label is visible through the pocket and is retained securely in the transparent pocket.

In another embodiment, the writable surface has a thickness of between about 5 and about 10 mil. In a preferred embodiment, the writable surface consists primarily of a polypropylene film having a thickness of about 6 to 7 mil.

The invention also provides a method for producing a flexible fastener having a writable surface by providing a loop and hook fastener substrate comprising loop and hook elements that are permanently embedded onto and extend outwardly from a common side of the substrate. A writable film comprising polypropylene or polyethylene is adhered to the loop and hook fastener substrate thereby producing a flexible laminate sheet having the loop and hook elements substantially covering a first side of the laminate sheet and the writable film substantially covering a second side of the laminate sheet. The flexible laminate sheet can be cut into a plurality of flexible fasteners, wherein the flexible fasteners are adapted for mating of the loop and hook elements by a single pinching motion thereby providing a flexible fastener having a writable labeling surface.

The loop elements and hook elements may be intermixed on the loop and hook substrate or may be disposed in alternating bands on the loop and hook fastener substrate. In one embodiment, the substrate is manufactured by first generating a soft woven sheet of loop material followed by permanently adhering hook elements over a portion of the loop material thereby generating a single substrate comprising both loop and hook elements.

In still another embodiment, the hook elements are disposed over the substrate such that approximately one-half of a longitudinal dimension of the substrate is covered with loop elements and approximately one-half of a longitudinal dimension of the substrate is covered with hook elements. Folding of the substrate in half along its lateral dimension fully engages the hook elements against the loop elements. In another embodiment, the fastener substrate is provided in rolls having a desired width of the final fastener. In certain embodiments the width of the fastener substrate is approximately about 4 to about 8 inches in width and has hook elements covering approximately one fourth to one-half of the width. Thus, for a fastener substrate having a width of 4 inches, the hook elements may be disposed over approximately 1-2 inches of the width of the 4 inch roll. In one embodiment the hook elements cover one-half of the total width of a fastener substrate having a total width of about 4, 5, 6, 7 or 8 inches. In another embodiment wide fasteners having a total width of up to about 13 inches and thus a folded together width of approximately 6½ inches is provided.

In yet another embodiment of the invention, printed images are applied to the writable film prior to adhering to the hook and loop substrate. The images may optionally be printed using a high volume roll-fed printing press, such as for example a flexographic printing press.

In one embodiment a printable fastener substrate is provided including a flexible laminate sheet having a light weight loop and hook fastener substrate substantially covering a first side of the laminate sheet and a 5 to 10 mil polypropylene film substantially covering a second side of the laminate sheet, wherein the loop and hook fastener substrate comprises hook and loop elements that are permanently embedded onto and extend outwardly from the substrate and are exposed on the first side of the laminate sheet, and wherein the polypropylene film is adapted for receiving printed images. The substrate can be supplied for custom consumer printing either directly on the fastener substrate or using transfer film. The substrate is optionally provided with perforations for separation of individual fasteners after printing.

### DESCRIPTION THE DRAWINGS

FIG. 1 is a diagram of the hook and loop fastener side of one embodiment of the invention.

FIG. 2 depicts a writable surface side of one embodiment of the invention.

FIG. 3 diagrammatically depicts a fastener substrate to which a removable label can be placed on top of the writable surface or can be inserted in a transparent sleeve on the writable surface.

FIG. 4 diagrammatically depicts certain steps in the manufacture of a bundling and labeling device according to one embodiment of the invention.

FIG. 5 depicts the bundling and labeling device being used to bundle cables in accordance with one embodiment of the invention.

### DETAILED DESCRIPTION OF THE INVENTION

In one aspect of the present invention, a flexible bundling device is provided having a unique orientation of hook and loop material on a single inside surface of a substrate so that no wrapping process is required to secure wires or cables. This orientation frequently proves to be an easier process than that of the wrapping oriented bundling devices. In addition, provision of a substrate having both hook and loop material integrally bonded provides for high resistance to shear forces when bundling device is tightly wrapped such as when a large number of cables are secured together. Further, due to this orientation of the hook and loop material where the hook and loop elements are formed on the same substrate and cannot slide away from each other when mounted on a further substrate, the device provides additional functionality for the outside surface of the substrate, so that it can be used to display information that has been either preprinted on the device, preprinted on a label capable of attaching to the substrate, or hand-written onto the substrate itself. Both the outside surface characteristics and the label insertion option, provide the capability for a high quality rendering of printed material. This will be suitable for corporate advertising, information that is uniquely provided by the individual consumer, or a combination of both. The information can be text or graphic images or a combination of both.

Where used in a bundling application, information provided by the consumer would typically be of a labeling nature, so as to distinguish the cable, wires, lines or conduits in the bundle from other bundled objects. This is particularly useful for applications where multiple devices with power cables are plugged into an AC power strip, where without labeling it is difficult to uniquely identify the equipment associated with a particular cable.

In one embodiment of the invention, the primary function of the fastener is labeling rather than bundling. For example, removable labels according to one embodiment of the present invention are dimensioned for attaching and providing a labeling surface for keys attached to rings such as at a car dealership or for valet parking. The labeling embodiment is useful for other indications where removable identification is required such as for example for placement on animal collars, halters etc. in veterinary and kennel operations. By using certain suitable markers, identifying indicia placed on the label can be removed and the label reused. As a consequence using a printable film applied to the fastener, advertising and promotional materials are readily and inexpensively produced. Where light weight hook and loop material is desired, the writable surface not only provides a printable surface for advertising but provides the important property of conferring sufficient rigidity for the label to be applied with a single pinching motion.

Hook and loop fasteners consist in simplest form of two mating elements. The loop elements typically comprise a mat of small soft loops. The loop elements can be napped or unnapped. Napped loop material consists of woven loops, typically nylon, that are “randomly disoriented” in a separate operation after weaving. Unnapped loop material is a woven loop material that has not been napped.

The hook elements are small flexible hooks that may be single crooks, double hooks, palm shaped hooks or mushroom shaped projections that engage loops of the loop elements when the hook and loop elements are pressed together resulting in closure of a fastener having opposing hook and loop elements. A closure of hook and loop elements is opened by peeling the hook and loop elements apart. Opening and closing of the hook and loop elements is termed a “cycle.” Typically, heavy duty hooks have lower cycle life than lightweight hooks.

In one embodiment, the hook and loop elements are formed on a common substrate material and both the hook and loop elements face the same direction. Engagement of the hook and loop elements is accomplished by folding. With this configuration, it is impossible for the hook and loop segments to shear in opposing directions, which is direction of shear pressure that occurs while bundling a cable for example. The common substrate material can be accomplished by either intermixing the hooks and loops, forming alternating rows of hook and loop on the same surface, or forming a portion of the common substrate with loop elements and another portion with hook elements. An example of an intermixed hook and loop configuration is presented in U.S. Pat. No. 5,515,583. An example of an alternating row configuration is the VELCRO-OMNI-TAPE fastener.

In a preferred embodiment, the hook and loop substrate is formed by a process in which a strip, sheet or mat of loop material is first formed. In a following step, hook elements are fused directly to the loop material across the entire back of the hook material but in such a way that portions of the loop material remain exposed. Thus, the resulting laminate substrate has both hook and loop elements disposed on the same side of the same substrate, the hook elements covering and thus abolished underlying loop elements. Such a method of manufacture is taught by Krantz et al. in U.S. patent application Ser. No. 09/808,395, published as U.S. 2002/0022108 AI, assigned to Velcro Industries.

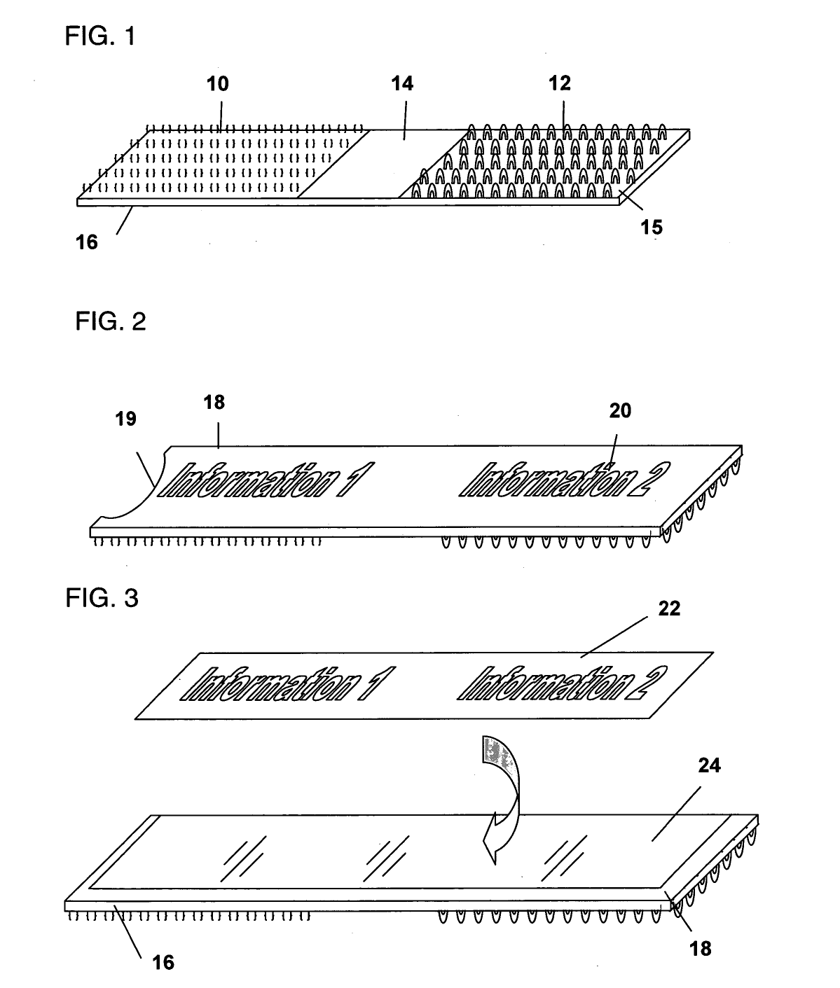

Referring to FIGS. 1-3, various embodiments of the invention are depicted. FIG. 1 depicts the fastener side of a bundling or labeling device. Hooks 10 and loops 12 are attached to the inside surface 15 of fastener substrate 16. The hook and loop material can be attached to the substrate by a variety of common bonding techniques, it can be stitched to the substrate, or the creation of the substrate with hook and loop material can be an integrated manufacturing process. In FIG. 1, area 14 is left open with no hook or loop and the substrate surface is exposed. Open area 14 may allow the device to more easily bend around the cable and wires to be bundled but is optional. In other embodiments it is preferred that the hook and loop areas abut one another and area 14 may be virtually absent in embodiments where the hook regions abut loop regions. The dimensions of the device are variable and will be offered in a range wide enough to address a variety of consumer applications. Typical dimensions for use in relatively small bundles of one or more wires, cables, conduits, tubing, pipes, lines, and combinations thereof would be a width of approximately ½ to one inch and length of approximately 4 to 8 inches.

FIG. 2 depicts outside surface 18, which is capable of containing information 20 that has been pre-printed or has been written onto the substrate by the user of the device. As shown in FIG. 2, the device can optionally be provided with a notch or tab 19 to facilitate separation of the hook and loop elements.

FIG. 3 depicts an alternate embodiment in which a removable label 22 is placed on the back of the writable surface 18. Alternatively, the fastener can be provided with a transparent sleeve 24 affixed to the writable surface 18 of fastener substrate 16. In this embodiment, a label can be inserted into the transparent sleeve 24. FIG. 5 depicts a typical view of one embodiment of the device securely bundling cables and providing a printed or writable surface for identifying the cable bundle.

### EXAMPLE 1

In developing the present invention cable ties were produced utilizing a vinyl writable surface sheet that provided a good combination of flexibility, durability and printability. The hook and loop material was attached in two sections. One section was for the hook and a separate section for the loop. The middle gap between the hook and loop sections was about ⅛th of an inch. The hook and loop material came from Velcro Corporation and was pre-coated with a rubber based pressure sensitive material.

However, after about two months of use, the bond of the adhesive became gooey with the hook and loop sections sliding away from each other in a lateral direction. This created a larger gap in the middle, up to ½ of an inch or more, with the hook and loop sections exposed on the ends and extending beyond the writable surface. The problem was magnified when the tie was in use with large cables and experiencing a significant shear stress against the adhesive bond. Heat (such as experienced in an automobile) also weakened the bond. It was determined that the inexpensive binder grade vinyl contained a plasticizer that evaporates over time. This attribute was responsible for the change in the strength of the adhesive bond.

### EXAMPLE 2

In order to avoid the problem of separation of the fastener portions from the writable surface, a vinyl with a higher quality plasticizer or an extruded vinyl (both higher cost) or a polymeric material without a plasticizer could be employed for the writable surface sheet or film. Polymeric films such as those containing primarily polyolefin, polypropylene or polyethylene that do not contain plasticizers were tested. The polyolefin film tested was produced in layers which separated. Single layer material is preferred to avoid this result. Although polyethylene is not as readily commercially available, it could be alternatively employed.

Polymeric film containing polypropylene was found to have the advantages of general availability, strength with retained flexibility, and the ability to accept printing from printing presses such as flexographic high volume printing presses used by many printers. In one embodiment for use in cable ties and labels for affixing to rings, the polypropylene is about 5 mil to about 10 mil in thickness.

In one embodiment, a writable polymeric film at least primarily composed of polypropylene having an approximately 6.5 mil thickness is employed. One suitable polypropylene sheet or film material is commercially available under the trade name ALPHAMAX from FLEXcon Corporation, 1 FLEXcon Industrial Park, Spencer, Mass., USA 01562-2642. ALPHAMAX EXPP 650 F is a flexible polypropylene film having a 6.5 mil thickness that is top-coated with a waterbased TC-106 coating to make the film printable. This material is compatible with acrylic adhesives such as the V-606 adhesive from FLEXcon. The 6.5 mil thickness was found to have a desirable combination of flexibility and strength for use such applications as cable ties. In one embodiment, the polypropylene film is ordered with the desired adhesive and size.

Polypropylene film was evaluated together with various acrylic adhesives. For commercial purposes the combined attributes of strength and cost effectiveness are relevant. Sheet or film material, such as 5 to 10 mil polypropylene, may be ordered with or without pressure sensitive adhesive on the back.

Where the sheet material is supplied without adhesive, a pressure sensitive adhesive can alternatively be supplied in the form of a separate transfer tape and applied as a secondary process. Polypropylene with the pressure sensitive adhesive already applied by the factory that produces the polypropylene may provide cost advantages.

A suitable adhesive should provide a strong and durable bond to the writable surface film. Particularly where the hook and elements are not formed on the same substrate, the adhesive must provide shear resistance. One suitable adhesive is the FLEXcon 606 adhesive and is preferably applied to the polypropylene film in a thickness of about 1.9 to 2.1 mil.

When hook and loop material is bonded to the sheet film that lacks volatile plasticizers, such as for example polypropylene, it has stronger resistance to shear due to the absence of plasticizer. Hook and loop material from various manufacturers is available in various configurations of the hooks and loop themselves as will as in different overall heights, and with different depths to the actual end of the hook. These characteristics influence the strength of attachment between the hooks and loops when engaged together.

In one embodiment, the hook and loop are on a common substrate material and both the hook and loop face the same direction. Engagement of the hook and loop elements is accomplished by folding. With this configuration, it is impossible for the hook and loop segments to shear in opposing directions, which is the direction of shear pressure that occurs while bundling a cable for example.

Various hook/loop configurations were tested. In one embodiment, a desirable combination of hook elements and loop elements for use in cable ties was selected for manufacture by Velcro Corporation on a common substrate that is 4 inches wide. Such material can be custom manufactured in various widths. In one embodiment, the preferred loop is a soft, lightweight loop material, such as is commercially available from VELCRO USA, INC. of Manchester, N.H. under the designation style LP 3905.

Of available choices, a VELCRO HTH 830 (polypropylene) hook was selected for combination with a 3905 knit nylon loop. The VELCRO 3905 loop is a low profile unnapped nylon warp knit. The VELCRO 830 hook is a polypropylene member of the High Technology Hook (HTH) 29 profile series and is characterized by 1700 hooks per square inch and a hook height of 0.5 mm. This hook was selected for superior engagement with low profile loops such as the VELCRO 3905 loop. This combination of hooks and loops material is characterized by a moderate peel strength between the hook/loop, but the materials were also compatible with a technology referred to by Velcro as FLEXZONE technology that forms hooks directly onto the loop fabric such that both hooks and loops are integral to a common substrate. Where the hooks and loops are formed on a common surface, they are not susceptible to movement against the writable film surface in response to the pressure of tight bundling or as a result of repeated cycling.

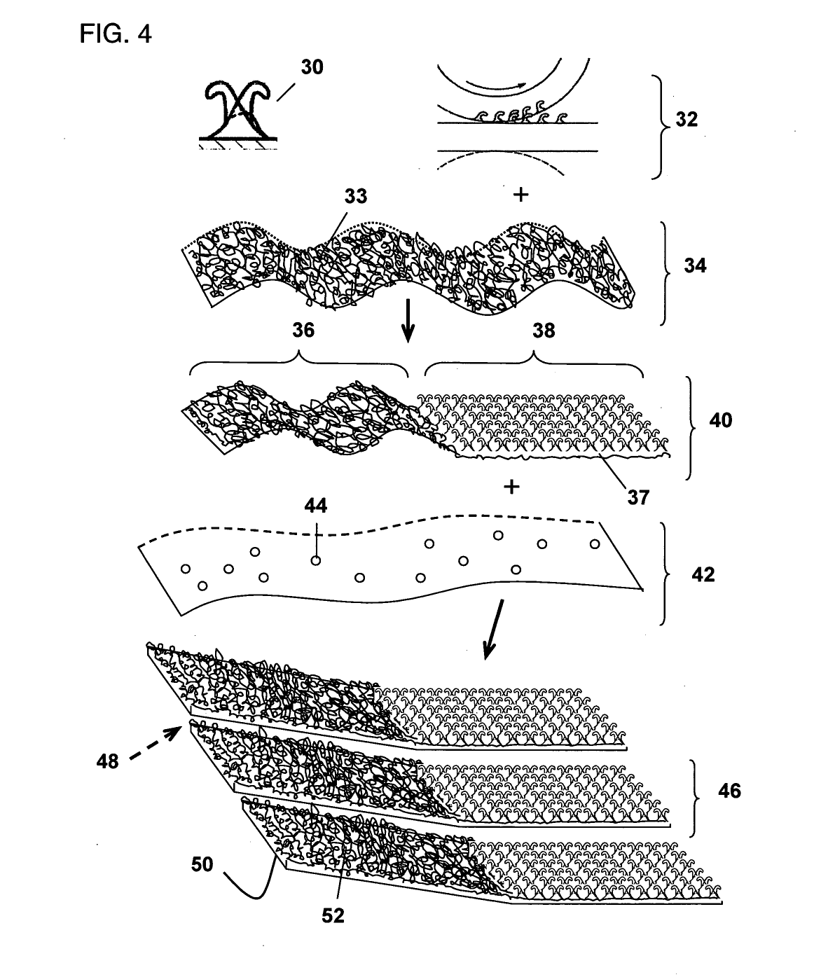

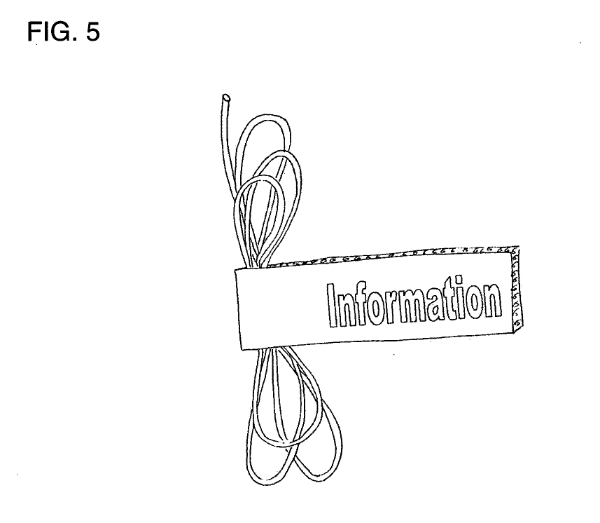

Velcro manufactures this material by a two step process as depicted in part in FIG. 4. In the first step, a common substrate 34 comprising nylon loops 33 is produced in various widths on a roll X yards long. A secondary process 32 as disclosed in Krantz et al. U.S. patent application Ser. No. 09/808,395, published as U.S. 2002/0022108 AI and assigned to Velcro Industries, forms a myriad of hooks 30, on top of the loops 33 in a hot injection molding process resulting in final hook and loop fastener substrate 40. However, such integral hook and loop material could alternatively be generated in several ways known to those of skill in the art including by fusing a strip of hook material to the loop substrate or weaving hook material with or through the loop fabric followed cutting or topping of the hook elements.

A number of configurations are possible. For example the loop material might be of a final desired width with hook elements disposed in a single longitudinal strip that may be approximately one fourth to one half of the total width. Alternatively, a wide mat of loops may serve as the base for alternating bands of overlaid and fused hook material that is subsequently cut to final desired dimensions. For example, to make 4 inch wide fasteners, the loop material could be 4 inches wide with a single 2 inch wide band of hooks, 8 inches wide with two 2 inch wide bands of hooks that is later cut in half longitudinally, twelve inches wide with three 2 inch wide bands of hooks that is later cut in three strips and so on. Fasteners of several final widths may be manufactured in a single run where, for example, 12 inch wide loop material has a two inch band of hooks laid down from 2 to 4 inches from one side and a second approximately 4 inch wide band laid down at approximately 8 inches from the same side. The resulting product is cut at 4 inches resulting in a roll of 4 inch fastener material and a roll of approximately 8 inch wide fastener material. Alternatively, hook and loop fastener substrates of virtually any width that can be manufactured on a single substrate can be used for the production of fasteners of this final width according to the invention. For example, hook and loop substrate material having widths of about 13 inches can be used to produce fasteners having a folded in half dimension of 6½ inches wide.

In the example depicted in FIG. 4, fastener substrate 40 is an X inch wide material hundreds of yards long, with a band of hook 38 and a band of loops 36 running in a longitudinal dimension. Fastener substrate 40 is preferably generated by an in situ hot injection molding process that forms hooks 30 directly on loop substrate 34. No adhesive is required to adhere the hook elements because they are formed in situ on the loop fabric. As depicted in FIG. 4, when using light weight loop material 34, the loop fabric is soft and flexible while in situ formation of hooks, such hooks 30 on loop substrate 34, results in a fastener substrate 40 that has a relatively stiff hook portion 38 and a relatively soft and floppy loop portion 36.

Referring again to FIG. 4, the following process may be employed to fashion a device in accordance with the invention. A common hook and loop fastener substrate 40 is provided in a custom configuration, X yards long. Polypropylene film 42 is supplied in rolls X yards long having a dimension essentially the same as that of hook-loop fastener substrate 40. In one embodiment, high volume roll-fed equipment prints images and text on polypropylene film 42. A pressure sensitive adhesive 44 is applied to the film 42, typically before printing. The polypropylene 42 is bonded to the hook and loop substrate 40, resulting in an essentially permanent laminate having a hook and loop fastener surface 52 and a writable polypropylene surface 50 wherein the application of the polypropylene film 42 confers a stiffening of the loop portion 36. As a consequence of the stiffening provided by the film, the fastener can be formed of thin flexible low profile hook and loop material and yet can be closed by a single pinching motion. The rolls of laminate are cut at points 48 to the desired width dimension, preferably in a high speed automated process. The final product 46 is a removable device that can be attached to an object and provides a labeling function and/or a bundling function.

This configuration was tested under the stress of large diameter cables and atmospheric temperatures over 90° F. for prolonged periods. Where the hook and loop was provided in the same substrate, the material was not observed to shear against the polypropylene.

### EXAMPLE 3

In another embodiment, a portion of the polypropylene film surface is covered with a transparent pocket as depicted in FIG. 3 that allows insertion of a printed label, wherein the printing on the label is visible and the label is retained securely between the transparent film and the surface of the substrate.

### EXAMPLE 4

In yet another embodiment, a version of the product that is printable by the consumer is provided. In this embodiment, the writable fastener material is supplied in sheet or roll form that is compatible with home and small office printers, either ink-jet or laser, that are able to accommodate thick stock sheets or rolls. Common software applications are employed in the creation of designs to be printed on the sheet or roll or on transfer film that is then applied to the fastener material. In one embodiment, the sheet or roll has perforations that define a final size of the writable fastener. The final custom printed fasteners are either cut to desired size or are separated at perforations.

### EXAMPLE 5

In still another embodiment of the invention, the primary function of the fastener is labeling rather than bundling. For example, removable labels according to this embodiment are dimensioned for attaching and providing a labeling surface for keys attached to rings such as at a car dealership or for valet parking. The labeling embodiment is useful for other indications where removable identification is required such as for example for placement on animal collars, halters etc in veterinary and kennel operations. By using certain suitable markers, identifying indicia placed on the label can be removed and the label reused. As a consequence of printable film applied to the fastener, advertising and promotional materials are readily and inexpensively produced. Where light weight hook and loop material is desired, the writable surface not only provides a printable surface for advertising but provides the important property of conferring sufficient rigidity for the label to be applied with a single pinching motion.

While the invention has been disclosed with respect to a limited number of embodiments, numerous modifications and variations will be appreciated by those skilled in the art. It is intended, therefore, that the following claims cover all such modifications and variations that may fall within the true sprit and scope of the invention.

We claim:

1. A writable fastener device comprising:
a flexible fastener substrate comprising a plurality of loop and hook elements, wherein both loop and hook elements are permanently embedded onto and extend outwardly from a first side of the fastener substrate; and
a polymeric film adhered to and substantially covering a second side of the fastener substrate, wherein the fastener substrate and film together form a writable fastener device that may be closed by a single folding motion.

2. The labeling device of claim 1, wherein the labeling device is dimensioned for fastening around one or more objects selected from the group consisting essentially of wires, cables, conduits, tubing, pipes, lines, and combinations thereof.

3. The labeling device of claim 1, wherein the writable fastener device is dimensioned for fastening to a ring closure thereby providing a removable label.

4. The labeling device of claim 1, wherein the polymeric film is adapted to be written upon with a writing instrument selected from the group consisting essentially of ball-point, felt, and gel pens.

5. The labeling device of claim 1, wherein the polymeric film is adapted to receive an image applied by a process selected from the group consisting essentially of ink-jet printing, laser printing, silk-screen printing, and embroidery.

6. The labeling device of claim 1, wherein at least a portion of the polymeric film surface further comprises a transparent pocket for insertion of a label, wherein the label is visible through the pocket and is retained securely in the transparent pocket.

7. The labeling device of claim 1 wherein the polymeric film comprises polypropylene or polyethylene and has a thickness of between about 5 mil and about 10 mil.

8. The labeling device of claim 7 wherein the polymeric film comprising polypropylene or polyethylene has a thickness of about 6 to about 7 mil.

9. A method for producing a flexible fastener having a writable surface comprising:
providing a loop and hook fastener substrate comprising loop and hook elements that are permanently embedded onto and extend outwardly from a first side of the substrate;
providing a writable polymeric film;
adhering the loop and hook fastener substrate to the writable polymeric film thereby producing a flexible laminate sheet having the loop and hook elements substantially covering a first side of the laminate sheet and the writable polymeric film substantially covering a second side of the laminate sheet;
cutting the flexible laminate sheet into a plurality of flexible fasteners, wherein the flexible fasteners are adapted for mating of the loop and hook elements by a single pinching motion thereby providing a flexible fastener having a writable labeling surface.

10. The method of claim 9, wherein loop elements and hook elements are intermixed on the loop and hook substrate.

11. The method of claim 9, wherein the loop elements and hook elements are disposed in alternating bands on the loop and hook fastener substrate.

12. The method of claim 9 wherein the substrate is manufactured by first generating a soft woven sheet of loop material followed by permanently adhering hook elements over at least a portion of the loop material thereby generating a single substrate comprising both loop and hook elements.

13. The method of claim 12, wherein the substrate is provided in roll having a width of approximately about 4 to about 13 inches.

14. The method of claim 13, wherein the hook elements are disposed over approximately one half of the width of the roll.

15. The method of claim 9, wherein the hook elements are disposed over the substrate such that approximately one-half of a longitudinal dimension of the substrate is covered with loop elements and approximately one-half of a longitudinal dimension of the substrate is covered with hook elements.

16. The method of claim 9 wherein the writable polymeric film comprises printed images that are applied to the film prior to adhering to the hook and loop substrate.

17. The method of claim 16, wherein the images are printed using a high volume roll-fed printing press.

18. The method of claim 9, wherein the writable polymeric film comprises polypropylene or polyethylene and has a thickness of between about 5 mil and about 10 mil.

19. The method of claim 9, wherein the flexible fastener is dimensioned for labeling and organizing wires, cables, conduits, tubing, pipes, and ring closures.

20. The method of claim 9, wherein the writable polymeric film is adhered to the loop and hook fastener substrate using pressure sensitive adhesive.

21. A printable fastener substrate comprising a flexible laminate sheet comprising a light weight loop and hook fastener substrate substantially covering a first side of the laminate sheet and a polypropylene film having a thickness of about 5 to about 10 mil substantially covering a second side of the laminate sheet, wherein the loop and hook fastener substrate comprises hook and loop elements that are permanently embedded onto and extend outwardly from the substrate and are exposed on the first side of the laminate sheet, and wherein the polypropylene film is adapted for receiving printed images.

22. The printable fastener substrate of claim 21, wherein the polypropylene film has a thickness of about 6 to about 7 mils.
